(19) United States
(12) Patent Application Publication
(10) Pub. No.: US 2013/0191507 A1
(43) Pub. Date: Jul. 25, 2013

(54) METHOD AND APPARATUS FOR SHARING IMAGES

(71) Applicant: Marko Tapio Tuukkanen, Schlenzer (DE)

(72) Inventor: Marko Tapio Tuukkanen, Schlenzer (DE)

(73) Assignee: NOKIA CORPORATION, Espoo (FI)

(21) Appl. No.: 13/807,588

(22) PCT Filed: Jun. 28, 2010
(86) PCT No.: PCT/FI2010/050553

§ 371 Date: Apr. 11, 2013

(51) Int. Cl. H04L 29/08

(52) U.S. Cl. CPC H04L 67/06
USPC 709/217

(57) ABSTRACT

In accordance with an example embodiment a method and apparatus is provided. The method comprises receiving a composite image comprising a plurality of images. Further, the method comprises sending a request over a network for at least one individual image. Moreover, the method comprises receiving the at least one individual image. The apparatus comprises at least one processor and at least one memory. The memory comprises computer program code, the at least one memory and the computer program code configured to, with the at least one processor, cause the apparatus at least to perform receiving a composite image comprising a plurality of images; enabling selection of at least one individual image from the plurality of images; sending a request over a network for the at least one individual image; and receiving the at least one individual image.

### TECHNICAL FIELD

Various implementations relate generally to method, apparatus, and computer program product for sharing images.

### BACKGROUND

Communication networks are becoming increasingly popular these days. Some examples of communication networks include mobile communication networks, computer networks, and short range wireless communication networks. Some examples of mobile communications networks include global system for mobile networks, 3^{rd} generation networks, and 4^{th} generation networks. Some examples of computer networks include local area networks, wide area networks, and the Internet. Some examples of the short range wireless communications networks include Bluetooth® networks, Zigbee®, and Institute of Electric and Electronic Engineers (IEEE) 802.11x networks.

These communication networks enable users to communicate and share information or content with each other. Some examples of the information include videos, text, music, and images. For example, a user can share images with another user over the Internet. Currently, if a user needs to share images with another user, he needs to share them individually. This may require substantial amount of time and network resources for sharing the individual images.

### SUMMARY OF SOME EMBODIMENTS

Various aspects of examples of the invention are set out in the claims.

First aspect provides a method comprising receiving a composite image comprising a plurality of images. Further, the method comprises sending a request over a network for the at least one individual image. Moreover, the method comprises receiving the at least one individual image.

Second aspect provides an apparatus comprising at least one processor; and at least one memory comprising computer program code, the at least one memory and the computer program code configured to, with the at least one processor, cause the apparatus at least to perform: receiving a composite image comprising a plurality of images; sending a request over a network for the at least one individual image; and receiving the at least one individual image.

Third aspect provides an apparatus comprising at least one processor and at least one memory comprising computer program code, the at least one memory and the computer program code configured to, with the at least one processor, cause the apparatus at least to perform transmitting a composite image comprising a plurality of images; receiving a request over a network for sending at least one individual image from the plurality of images selected by a recipient of the composite image; and transmitting the at least one individual image to the recipient.

Fourth aspect provides a computer program product comprising computer program instructions which when executed by an apparatus cause the apparatus to perform: receiving a composite image comprising a plurality of images; sending a request over a network for the at least one individual image; and receiving the at least one individual image.

Fifth aspect provides a computer program product comprising computer program instructions, which when executed by an apparatus, cause the apparatus to perform: transmitting a composite image comprising a plurality of images; receiving a request over a network for sending at least one individual image from the plurality of images selected by a recipient of the composite image; and transmitting the at least one individual image to the recipient.

Sixth aspect provides an apparatus comprising means for receiving a composite image comprising a plurality of images; means for sending a request over a network the at least one individual image; and means for receiving the at least one individual images.

Seventh aspect provides an apparatus comprising means for transmitting a composite image comprising a plurality of images; means for receiving a request over a network for sending at least one individual image from the plurality of images selected by a recipient of the composite image; and means for transmitting the at least one individual image to the recipient.

Eighth aspect provides a computer program comprising program instructions which when executed by an apparatus cause the apparatus to perform: receiving a composite image comprising a plurality of images; sending a request over a network for the at least one individual image; and receiving the at least one individual image.

Ninth aspect provides a computer program comprising program instructions which when executed by an apparatus cause the apparatus to perform: transmitting a composite image comprising a plurality of images; receiving a request over a network for sending at least one individual image from the plurality of images selected by a recipient of the composite image; and transmitting the at least one individual image to the recipient.

### BRIEF DESCRIPTION OF THE FIGURES

For a more complete understanding of example embodiments of the present invention, reference is now made to the following descriptions taken in connection with the accompanying drawings in which:

FIG. 1 illustrates an example network in which various embodiments may be practiced;

FIG. 2 illustrates a communication device in accordance with an example embodiment;

FIG. 3 illustrates an apparatus in accordance with an example embodiment;

FIG. 4 illustrates an apparatus in accordance with another example embodiment;

FIG. 5 is a flowchart depicting an example method for transmitting images in accordance with an example embodiment;

FIG. 6 is a flowchart depicting an example method for receiving images in accordance with another example embodiment;

FIG. 7 is a flowchart depicting an example method for sharing images in accordance with an example embodiment;

FIG. 8 is a flowchart depicting an example method for receiving images in accordance with another example embodiment; and

FIG. 9 depicts example formats of a composite image in accordance with an example embodiment.

### DETAILED DESCRIPTION

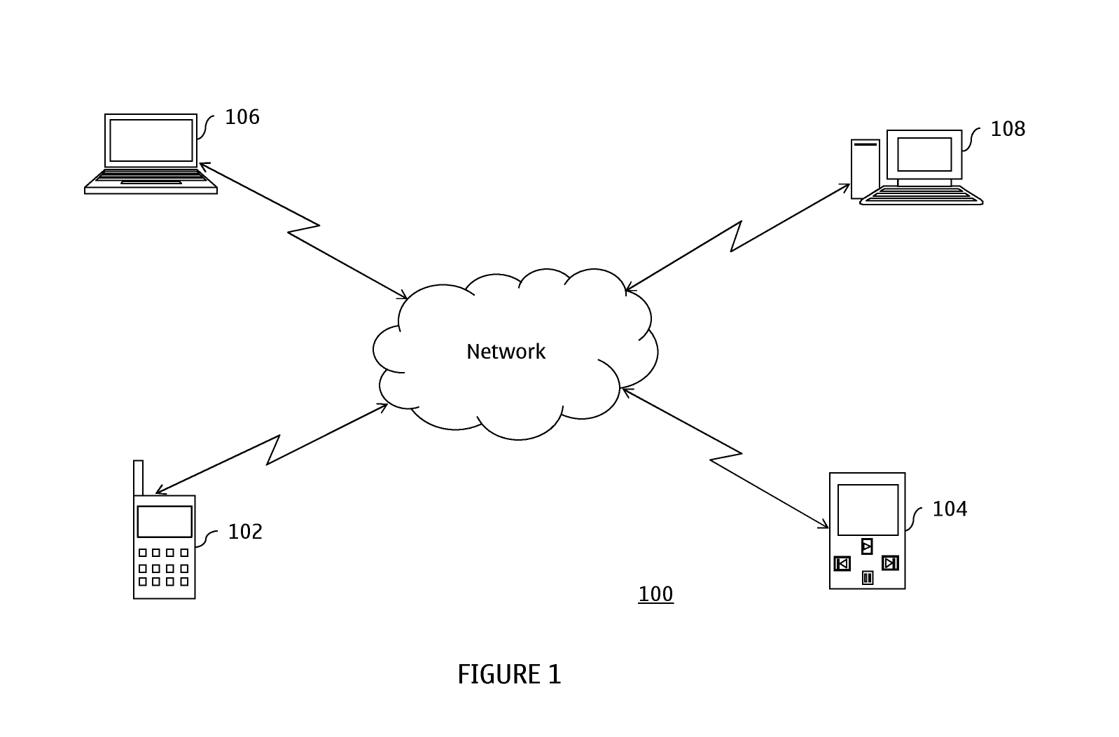

Example embodiments their potential advantages are understood by referring to FIGS. 1 through 9 of the drawings.

FIG. 1 illustrates an example network 100 in which various embodiments may be practiced. The network 100 may comprise, but is not limited to, telecommunication networks, computer networks, short range wireless communication networks, and combination thereof. Some examples of telecommunication networks include global system for mobile networks, second-generation (2G) wireless communication networks IS-136 (time division multiple access (TDMA)) networks, IS-95 (code division multiple access (CDMA)) networks, third-generation (3G) networks, such as Universal Mobile Telecommunications System (UMTS), CDMA2000 networks, wideband CDMA (WCDMA) networks and time division-synchronous CDMA (TD-SCDMA) networks, 3.9G wireless communication networks such as evolved-universal terrestrial radio access network (E-UTRAN) networks, fourth-generation (4G) wireless networks, public switched telecommunication networks, and the like. Some examples of computer networks may include the Internet, local area network, wide area networks, and the like. Some examples of the short range wireless communication networks may include Bluetooth® networks, Zigbee® networks, Institute of Electric and Electronic Engineers (IEEE) 802.11x networks, and the like.

The network 100 may include a plurality apparatuses. Some examples of these apparatuses include mobile communication devices, wireline communication devices, multimedia devices with communication capabilities, combination thereof, and the like. Examples of mobile communication devices include, but are not limited to, mobile phones, personal digital assistants, mobile digital assistants, pagers, laptops, pocket personal computers, smartphones, mobile computers, and eBooks. Examples of fixed line communication devices include, but are not limited to, landline phone with multimedia capabilities, and desktop computers. Examples of multimedia devices with communication capabilities include, but are not limited to, cameras, mobile televisions, audio/video players, radios, gaming devices, and media players.

The network 100 may enable plurality of apparatuses to communicate and/or share information or content with each other. The apparatuses may have communication capabilities and in an example embodiment, may be referred to as communication devices. In an example embodiment, the network 100 may comprise a mobile phone 102, a media player with communication capabilities 104, a laptop 106, and a desktop computer 108. In an example embodiment, the mobile phone 102, the media player 104, the laptop 106, and the desktop computer 108 may be collectively referred to as communication devices. Though the network is shown to include the mobile phone 102, the media player 104, the laptop 106, and the desktop computer 108, the network 100 may include more or fewer number of apparatuses and/or any other apparatuses that are capable of communicating in networks, for example, the network 100.

The network 100 may enable the communication devices to share information or content amongst each other. For example, the mobile phone 102 may transmit a composite image comprising a plurality of images to the laptop 106. In an example embodiment, an image may be a video, an audio, or any other media content. In an example embodiment, an apparatus transmitting composite image may be referred as a transmitting apparatus. In an example embodiment, the composite image may be a collage from which the plurality of images are inseparable. Once the composite image is received by the laptop 106, a user of the laptop 106 may select individual images from the composite image. In an example embodiment, the individual images are selected by the laptop without an input from the user. In an example embodiment, an apparatus receiving the composite image may be referred as a receiving apparatus. In an example embodiment, the laptop 106 may send a request for the individual images in response to the individual images selected by the user. In another example embodiment, the request for individual images may be sent automatically, for example, with no or minimal intervention by the user. The individual images are received by the laptop 106. In an example embodiment, the received individual images are images that are originally stored at a transmitting apparatus.

In an example embodiment, the laptop 106 may forward the composite image to the media player 104. In an example embodiment, an apparatus receiving the forwarded composite image may be referred to as a further apparatus.

Though the above embodiment is explained with help of the mobile phone 102 as a transmitting apparatus, the laptop 106 as a receiving apparatus, and the media player 104 as a further apparatus, the present embodiment may be explained or practiced with help of any other communication devices.

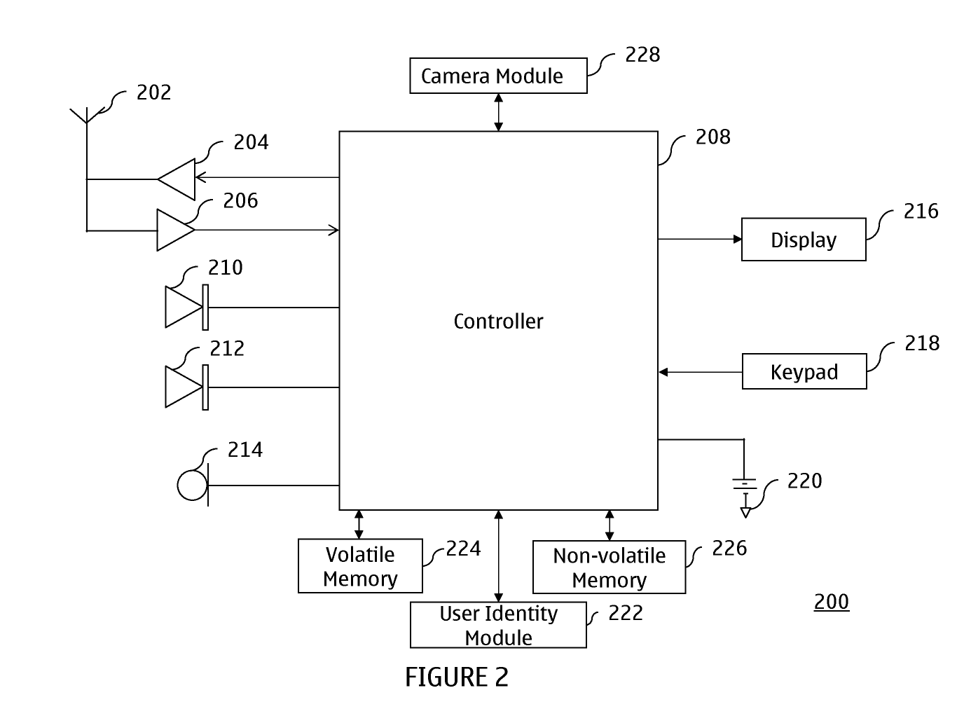

FIG. 2 illustrates a communication device 200 in accordance with an example embodiment. It should be understood, however, that the communication device as illustrated and hereinafter described is merely illustrative of one type of device that may benefit from various embodiments, therefore, should not be taken to limit the scope of the embodiments. As such, it should be appreciated that at least some of the components described below in connection with the communication device 200 may be optional and thus in an example embodiment may include more, less or different components than those described in connection with the example embodiment of FIG. 2. The communication device 200 of FIG. 2 could be any of a number of types of mobile electronic devices such as, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications systems.

The communication device 200 may include an antenna 202 or multiple antennas in operable communication with a transmitter 204 and a receiver 206. The communication device 200 may further include an apparatus, such as a controller 208 or other processing device that provides signals to and receives signals from the transmitter 204 and receiver 206, respectively. The signals may include signaling information in accordance with the air interface standard of the applicable cellular system, and/or may also include data corresponding to user speech, received data and/or user generated data. In this regard, the communication device 200 may be capable of operating with one or more air interface standards, communication protocols, modulation types, and access types. By way of illustration, the communication device 200 may be capable of operating in accordance with any of a number of first, second, third and/or fourth-generation communication protocols or the like. For example, the communication device 200 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the communication device 200 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network.

The controller 208 may include circuitry implementing, among others, audio and logic functions of the communication device 200. For example, the controller 208 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the communication device 200 are allocated between these devices according to their respective capabilities. The controller 208 thus may also include the functionality to convolutionally encode and interleave message and data prior to modulation and transmission. The controller 208 may additionally include an internal voice coder, and may include an internal data modem. Further, the controller 208 may include functionality to operate one or more software programs, which may be stored in a memory. For example, the controller 208 may be capable of operating a connectivity program, such as a conventional web browser. The connectivity program may then allow the communication device 200 to transmit and receive web content, such as location-based content and/or other web page content, according to a Wireless Application Protocol (WAP), Hypertext Transfer Protocol (HTTP) and/or the like, for example. In an example embodiment, the controller 208 may be embodied as a multi-core processor such as a dual or quad core processor. However, any number of processors may be included in the controller 208.

The communication device 200 may also comprise a user interface including an output device such as a ringer 210, an earphone or speaker 212, a microphone 214, a display 216, and a user input interface, which may be coupled to the controller 208. The user input interface, which allows the communication device 200 to receive data, may include any of a number of devices allowing the communication device 200 to receive data, such as a keypad 218, a touch display, a microphone or other input device. In embodiments including the keypad 218, the keypad 218 may include numeric (0-9) and related keys (#, *), and other hard and soft keys used for operating the communication device 200. Alternatively, the keypad 218 may include a conventional QWERTY keypad arrangement. The keypad 218 may also include various soft keys with associated functions. In addition, or alternatively, the communication device 200 may include an interface device such as a joystick or other user input interface. The communication device 200 further includes a battery 220, such as a vibrating battery pack, for powering various circuits that are used to operate the communication device 200, as well as optionally providing mechanical vibration as a detectable output.

In an example embodiment, the communication device 200 includes a media capturing element, such as a camera, video and/or audio module, in communication with the controller 208. The media capturing element may be any means for capturing an image, video and/or audio for storage, display or transmission. In an example embodiment, in which the media capturing element is a camera module 228, the camera module 228 may include a digital camera capable of forming a digital image file from a captured image. As such, the camera module 228 includes all hardware, such as a lens or other optical component(s), and software necessary for creating a digital image file from a captured image. Alternatively, the camera module 228 may include only the hardware needed to view an image, while a memory device of the communication device 200 stores instructions for execution by the controller 208 in the form of software to create a digital image file from a captured image. In an example embodiment, the camera module 228 may further include a processing element such as a co-processor which assists the controller 208 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 228 may provide live image data to the display 216. Moreover, in an example embodiment, the display 216 may be located on one side of the communication device 200 and the camera module 228 may include a lens positioned on the opposite side of the communication device 200 with respect to the display 216 to enable the camera module 228 to capture images on one side of the communication device 200 and present a view of such images to the user positioned on the other side of the communication device 200.

The communication device 200 may further include a user identity module (UIM) 222. The UIM 222 may be a memory device having a processor built in. The UIM 222 may include, for example, a subscriber identity module (SIM), a universal integrated circuit card (UICC), a universal subscriber identity module (USIM), a removable user identity module (R-UIM), or any other smart card. The UIM 222 typically stores information elements related to a mobile subscriber. In addition to the UIM 222, the communication device 200 may be equipped with memory. For example, the communication device 200 may include volatile memory 224, such as volatile Random Access Memory (RAM) including a cache area for the temporary storage of data. The communication device 200 may also include other non-volatile memory 226, which may be embedded and/or may be removable. The non-volatile memory 226 may additionally or alternatively comprise an electrically erasable programmable read only memory (EEPROM), flash memory, hard drive, or the like. The memories may store any of a number of pieces of information, and data, used by the communication device 200 to implement the functions of the communication device 200.

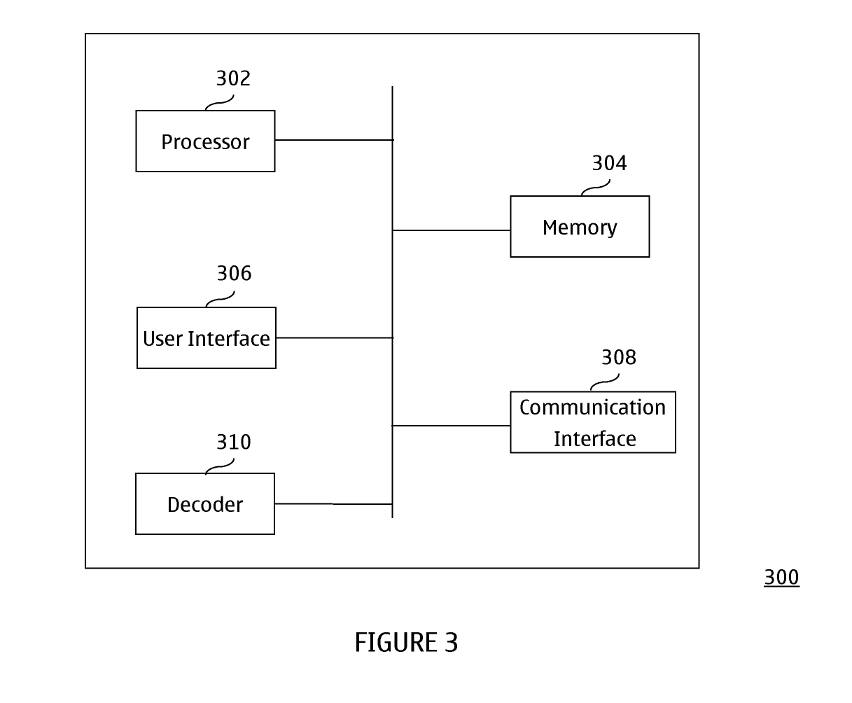

FIG. 3 illustrates an apparatus 300 in accordance with an example embodiment. The apparatus 300 may be employed, for example, in the communication device 200 of FIG. 2. However, it should be noted that the apparatus 300, may also be employed on a variety of other devices both mobile and fixed, and therefore, embodiments should not be limited to application on devices such as the communication device 200 of FIG. 2. Alternatively, embodiments may be employed on a combination of devices including, for example, those listed above. Accordingly, various embodiments may be embodied wholly at a single device, for example, the communication device 200 or by devices in a client/server relationship. Furthermore, it should be noted that the devices or elements described below may not be mandatory and thus some may be omitted in certain embodiments.

In an example embodiment, the apparatus 300 may enable receiving images in a network. In an example embodiment, the apparatus 300 may be referred to as a receiving apparatus 300. The apparatus 300 includes or otherwise is in communication with at least one processor 302, at least one memory 304, a user interface 306, and a communication interface 308. Examples of the memory 304 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 304 may be configured to store information, data, applications, instructions or the like for enabling the apparatus 300 to carry out various functions in accordance with various example embodiments. For example, the memory 304 may be configured to buffer input data for processing by the processor 302. Additionally or alternatively, the memory 304 may be configured to store instructions for execution by the processor 302.

The processor 302, which may be an example of the controller 208 of FIG. 2, may be embodied in a number of different ways. The processor 302 may be embodied as a multi-core processor, a single core processor; or combination of multi-core processors and single core processors. For example, the processor 302 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 304 or otherwise accessible to the processor 302. Alternatively or additionally, the processor 302 may be configured to execute hard coded functionality. As such, whether configured by hardware or software methods, or by a combination thereof, the processor 302 may represent an entity, for example, physically embodied in circuitry, capable of performing operations according to various embodiments while configured accordingly. Thus, for example, when the processor 302 is embodied as two or more of an ASIC, FPGA or the like, the processor 302 may be specifically configured hardware for conducting the operations described herein. Alternatively, as another example, when the processor 302 is embodied as an executor of software instructions, the instructions may specifically configure the processor 302 to perform the algorithms and/or operations described herein when the instructions are executed. However, in some cases, the processor 302 may be a processor of a specific device, for example, a mobile terminal or network device adapted for employing embodiments by further configuration of the processor 302 by instructions for performing the algorithms and/or operations described herein. The processor 302 may include, among other things, a clock, an arithmetic logic unit (ALU) and logic gates configured to support operation of the processor 302.

The user interface 306 may be in communication with the processor 302. Examples of the user interface 306, include but are not limited to, input interface and/or output interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the input interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 306 may include, among other devices or elements, any or all of a speaker, a microphone, a display, and a keyboard, touch screen, or the like. In this regard, for example, the processor 302 may comprise user interface circuitry configured to control at least some functions of one or more elements of the user interface, such as, for example, a speaker, ringer, microphone, display, and/or the like. The processor 302 and/or user interface circuitry comprising the processor 302 may be configured to control one or more functions of one or more elements of the user interface 306 through computer program instructions, for example, software and/or firmware, stored on a memory, for example, the memory 304, and/or the like, accessible to the processor 302.

The communication interface 308 may be any means such as a device or circuitry embodied in either hardware, software, or a combination of hardware and software that is configured to receive and/or transmit data, for example, a transceiver, from/to a network and/or any other device or module in communication with the apparatus 300. The communication interface 308 may include, for example, an antenna, or multiple antennas and supporting hardware and/or software for enabling communications with a wireless communication network. In an example embodiment, the communication interface 308 may alternatively or additionally support wired communication. As such, for example, the communication interface 308 may include a communication modem and/or other hardware and/or software for supporting communication via cable, digital subscriber line (DSL), universal serial bus (USB) or other mechanisms.

In an example embodiment, the processor 302 may be embodied as, include, or otherwise control, a decoder 310. The decoder 310, may be any mean such as a device or circuitry operating in accordance with software or otherwise embodied in hardware or a combination of hardware and software. For example, the processor 302 operating under software control, the processor 302 embodied as an ASIC or FPGA specifically configured to perform the operations described herein, or a combination thereof, thereby configuring the apparatus or circuitry to perform the corresponding functions the decoder 310.

In an example embodiment, the communication interface 308 is configured to receive a composite image comprising a plurality of images. In an example embodiment, an image may be a video, an audio, or any other media content. The composite image may be received via, for example, an email, instant message, multimedia messaging service, and the like. In an example embodiment, the composite image is a collage from which the individual images are inseparable. In an example embodiment, the composite image comprises identification details of the apparatus transmitting the composite image, individual identification of the plurality of images, information related to boundaries and central point of the plurality of images, date and time of capturing the plurality of images, date and time of creating the composite image, location information of the plurality of images, and/or the like. Alternatively or additionally, the composite image may include information of an apparatus from which the individual images may be received. For example, a transmitting apparatus transmits a collage of images that are available on a website of user, to a receiving apparatus. In this example, the transmitting apparatus also includes address of the web server or address of the website from which the individual images may be received. This information may be stored in an application file. An example of the application file includes, but is not limited to, XML format. The format of the composite image may be, for example, a joint photographic experts group, a joint photographic experts group interchange file formats, a bitmaps, exchangeable image format, a tagged image file format, a graphical interchange format, and the like.

The communication interface 308 is communicably coupled to, and provides the composite image to the decoder 310. The decoder 310 decodes the composite image. The decoded composite image may be displayed on a display, which may be an example of the user interface 306. A touch screen, which may be an example of the user interface 306, enables a user of the apparatus 300 to select at least one individual image from the plurality of images. Once the user has completed the selection of the individual images, the processor 302 causes the communication interface 308 to send a request over a network for the individual images. In an example embodiment, a notification for example, a pop-up, or dialog, may be displayed to the user asking to confirm completing the selection of the individual images. The notification may be defined in user settings, for example, ‘ask always’, or ‘never ask’. In another example embodiment, a predetermined gap, for example, 2 seconds after selecting last individual image may be used to indicate completion of selection of the individual images. In yet another example embodiment, the user may be provided with an option to complete the selection of the individual images from the composite. For example, the composite image may include a soft button, which when pressed by the user, may be used to indicate, completion of selection of the individual images. In an example embodiment, the apparatus 300 selects the individual images without an input from the user. In an example embodiment, the request may be automatically sent when the selection of the individual images is complete. In an example embodiment, the composite image may be discarded once the selection of the individual images is complete. In another example embodiment, the composite image is stored in a non-volatile memory, which may be an example of the memory 304.

The processor 302 may also cause the communication interface 308 to receive the individual images. In an example embodiment, the individual images are received from an another apparatus. The another apparatus is different from the apparatus to which the request for individual images is sent. In this embodiment, the composite image comprises details of the another apparatus from which the individual images may be received. Some examples of the another apparatus includes, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, web servers, or any combination of the aforementioned, and other types of communications systems. The individual images may be stored on a non-volatile memory, which may be an example of the memory 304. In an example embodiment, a resolution and/or a size of the plurality of images in the composite image are less than a resolution and/or a size of the received individual images. In an example embodiment, the communication interface 308 is also configured to forward the composite image comprising the plurality of images to a recipient of a further apparatus. The apparatus 300 may forward the composite image to the further recipient to share the images.

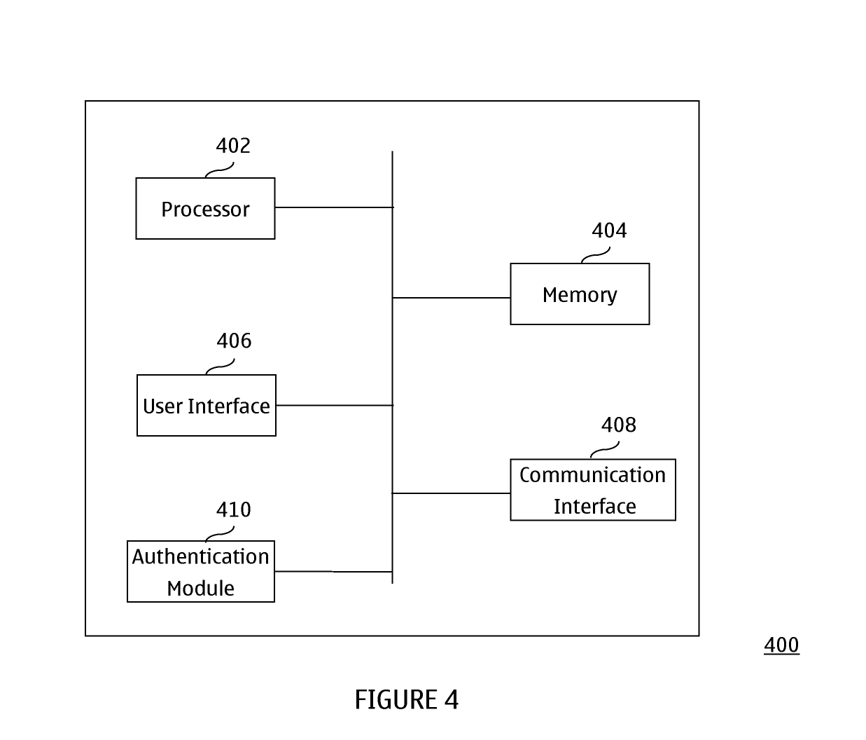

FIG. 4 illustrates an apparatus 400, in accordance with another example embodiment. The apparatus 400 may be employed, for example, in the communication device 200 of FIG. 2. However, it should be noted that the apparatus 400, may also be employed on a variety of other devices both mobile and fixed, and therefore, embodiments should not be limited to application on devices such as the communication device 200 of FIG. 2. Alternatively, embodiments may be employed on a combination of devices including, for example, those listed above. Accordingly, various embodiments may be embodied wholly at a single device, for example, the communication device 200 or by devices in a client/server relationship. Furthermore, it should be noted that the apparatuses or elements described below may not be mandatory and thus some may be omitted in certain embodiments.

In an example embodiment, the apparatus 400 may enable transmitting of images in a network. In an example embodiment, the apparatus 400 may be referred to as transmitting apparatus 400. The apparatus 400 includes or otherwise is in communication with at least one processor 402, at least one memory 404, a user interface 406, and a communication interface 408. An example of the processor 402 includes the processor 302. An example of the memory 404 includes the memory 304. An example of the user interface 406 includes the user interface 306. An example of the communication interface 408 includes the communication interface 308.

In an example embodiment, the processor 402 causes the user interface 406 to enable selection of an option for creating a composite image. The composite image may be created by using applications for creating a composite image available in or to the apparatus 400. In an example embodiment, a user of the apparatus is enabled to create the composite image by using the applications for creating the composite image. In another example embodiment, the apparatus creates the composite image without an input from the user. The composite image may be displayed on a display, which may be an example of the user interface 406.

In an example embodiment, the communication interface 408 is configured to transmit the composite image to a receiving apparatus, for example, the apparatus 300. The image may be a video, an audio, or any other media content. In an example embodiment, the communication interface 408 is also configured to receive a request over a network for transmitting individual images selected from a plurality of images by a recipient of the composite image. In response to receiving the request, the communication interface 408 is also configured to transmit the individual images to the recipient. In an example embodiment, the communication interface 408 may transmit the individual images to another apparatus. The another apparatus is different from the apparatus from which the request for individual images are received. In this example embodiment, the request for individual images also comprises details of the another apparatus. Some example of the another apparatus include portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, web servers, or any combination of the aforementioned, and other types of communications systems. In an example embodiment, the apparatus 400 may be configured to automatically send the individual images to the receiving apparatus.

In an example embodiment, the processor 402 may be embodied as, include, or otherwise control, an authentication module 410. The authentication module 410 may be configured to authenticate the receiving apparatus from which the request for individual images is received. The receiving apparatus may be authenticated based on phone number of the receiving apparatus, international mobile equipment identity (IMEI) number of the receiving apparatus, and/or a software identity of the application used to create the composite image.

In an example embodiment, the processor 402 causes the apparatus 400 to allow the recipient of the composite image to forward the composite image to a further apparatus. In an example embodiment, the further apparatus is allowed to send a request for the individual images. In an example embodiment, the processor may cause the transmitting apparatus to restrict the further apparatus from sending a request for individual images from the plurality of images in the composite image.

In an example embodiment, the processor 402 may cause the apparatus 400 to restrict the receiving apparatus from forwarding the composite image to the further apparatus. For example, user settings in the apparatus 400 may be defined to allow recipients to request and receive the individual images. If enabled, the apparatus 400 may receive requests for individual images and transmits the individual images to the apparatuses from which the requests are received. If disabled, a notification may be sent to the receiving apparatus. For example, the notification may be one of short messaging service message, multimedia messaging service message, an integrated notification from the software used to create and/or transmit the composite image, email, or the like. Forwarding the composite image from the receiving apparatus may be disabled as a new security feature and/or by using some existing copy protection mechanism. In addition, removing an XML file and/or details from the composite image, prior to forwarding, may prevent the further apparatus from requesting the individual images. This may be a feature added to the software and/or apparatus.

In an example embodiment, the transmitting apparatus does not authenticate the further apparatus, if the further apparatus is restricted from receiving the individual images. As a result, the further apparatus may not receive the individual images, even if the receiving apparatus forwards the composite image to the further apparatus and further apparatus sends a request for receiving the individual images.

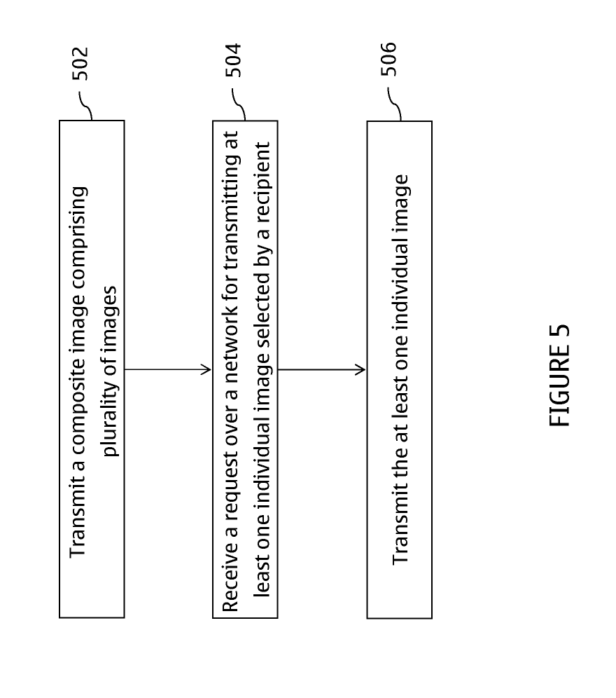

FIG. 5 is a flowchart depicting an example method for transmitting images in accordance with an example embodiment. The method depicted in the flowchart of FIG. 5 may be executed by, for example, the apparatus 400 of FIG. 4.

At block 502, a composite image comprising a plurality of images is transmitted. In an example embodiment, information related to a particular individual image may be also provided as a text. For example, time and date of capturing an individual image, and location of capturing the individual image may be provided as a text within the boundary and/or region of the particular image in the composite image.

At block 504, a request for sending at least one individual image from the plurality of images selected by a recipient of the composite image is received over a network, for example, network 100 of FIG. 1. At block 506, the at least one image is transmitted.

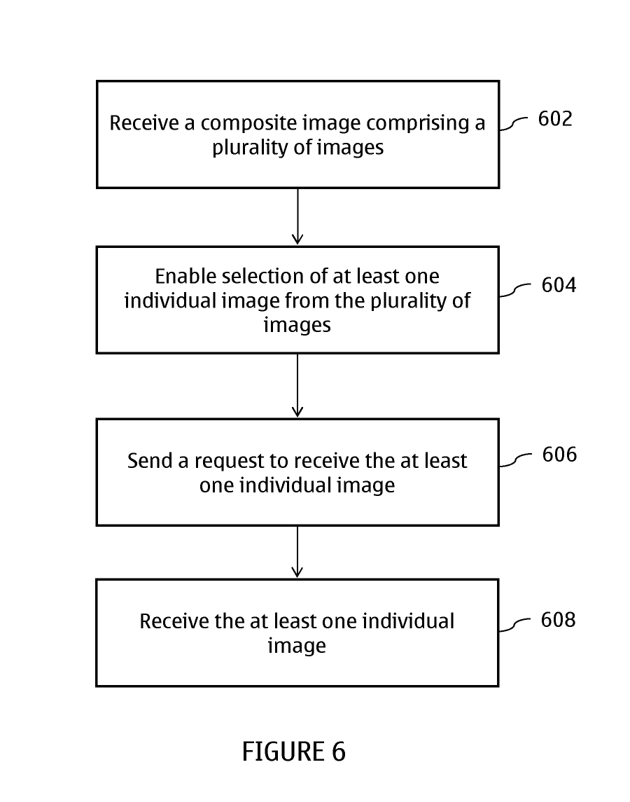

FIG. 6 is a flowchart depicting an example method for receiving images in accordance with an example embodiment. The method depicted in the flowchart of FIG. 6 may be executed by, for example, the apparatus 300 of FIG. 3.

At block 602, a composite image comprising a plurality of images is received. In an example embodiment, information related to a particular individual image may be received as text. For example, time and date of capturing an individual image, and location of capturing the individual image may be provided as a text within the boundary and/or region of the particular image in the composite image. In another example embodiment, some of the information related to a particular image may be displayed when a pointer is hovered over the particular image.

At block 604, selection of at least one individual image from the plurality of images in the composite image is enabled. In an example embodiment, a user of the apparatus 300 is enabled to select the individual images. In another example embodiment, the apparatus 300 is enabled to select the individual images without input from the user.

At block 606, a request is sent over a network, for example, to the transmitting apparatus 400, for receiving the individual images. In an example embodiment, the request for the individual images may be sent automatically. At block 608, the individual images are received, for example, by the receiving apparatus 300. In an example embodiment, the individual images are received by another apparatus. The another apparatus is different from the receiving apparatus 300. For example, a recipient accesses the composite image from a laptop, however, he wants to receive the individual images on a mobile phone. In this embodiment, the request for the individual images also includes details of the apparatus at which the individual images are to be received.

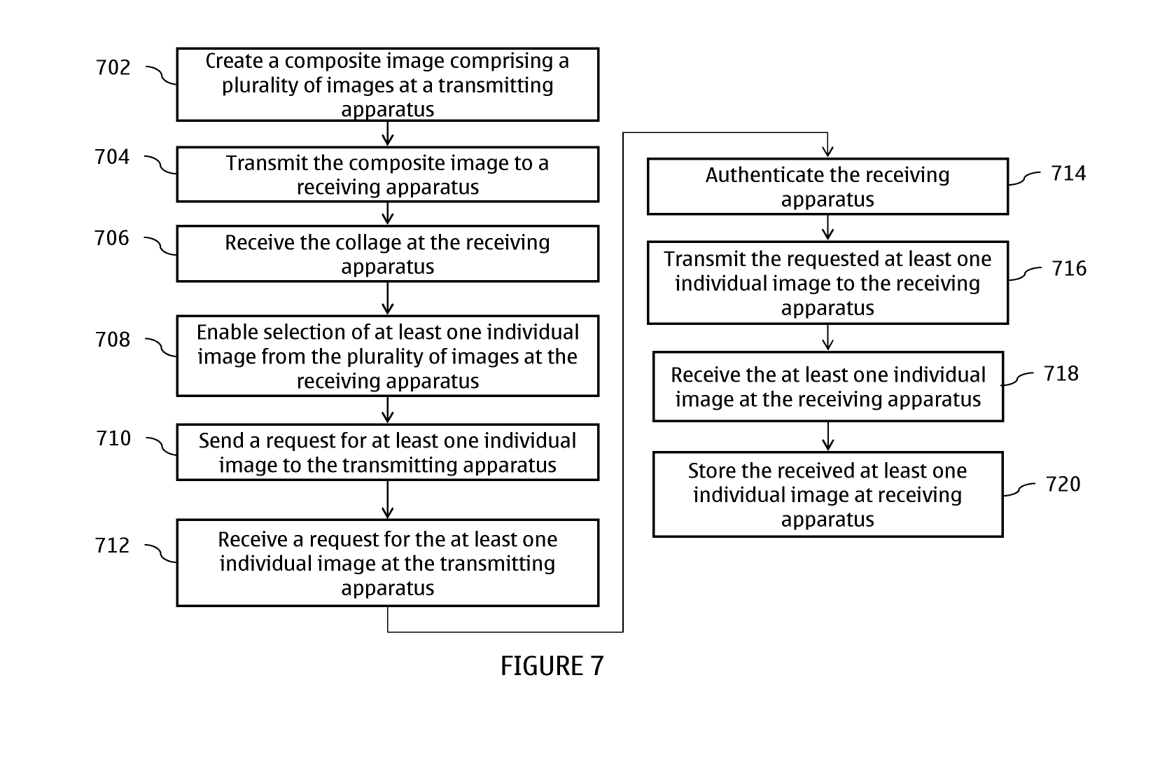

FIG. 7 is a flowchart depicting an example method for sharing images in accordance to another example embodiment. Blocks of the flowchart, and combinations of blocks in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions which embody the procedures described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the blocks specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the blocks specified in the flowchart. The computer program instructions may also be loaded onto a computer or other programmable apparatus to cause a series of blocks to be performed on the computer or other programmable apparatus to produce a computer-implemented process such that the instructions which execute on the computer or other programmable apparatus provide blocks for implementing the blocks in the flowchart. The blocks of the method are described with help of apparatus 300 as the receiving apparatus and apparatus 400 as the transmitting apparatus. However, the blocks of the method may be described and/or practiced by using any other communication apparatuses.

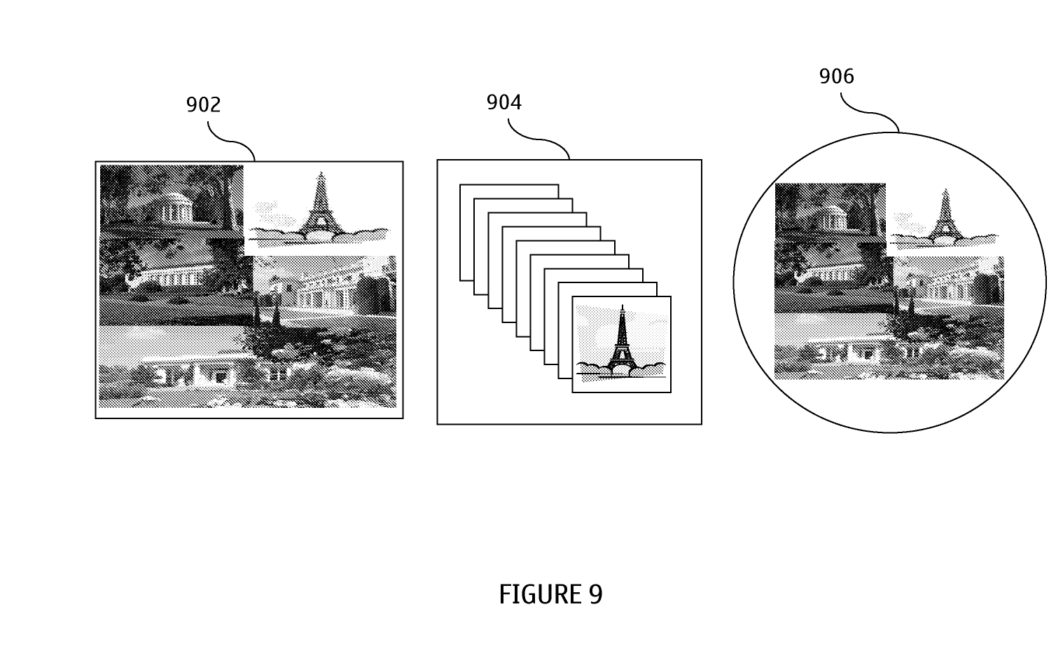

At block 702 a composite image is created, for example at the transmitting apparatus 400. In an example embodiment, the image may be a video, an audio, or any other media content. In an example, the user of the transmitting apparatus 400 is provided with an option to create composite image. The option may be visible to the user via the apparatus menus. In another example, the user may be provided with an application menu when the user selects two or more pictures. In yet another example, the user may select two or more images and choose to transmit them. Accordingly, the user may be provided an option to transmit the selected images as a composite image. In still another example, a composite image is automatically created when two or more images are selected. The user may select different options or types for creating a composite image. For example, a round composite image, an example of which is shown in FIG. 9, or a square composite image, an example of which is shown also in FIG. 9. Individual images in the composite image may be defined by the image boundaries. For example, in case of a square composite image, the image boundaries may be defined by horizontal and vertical axis. In another example, individual images in the composite image may be defined by a central point for the individual images.

At block 704, the transmitting apparatus 400 transmits the composite image, for example to the receiving apparatus 300. If desired, the composite image may be simultaneously sent to multiple apparatuses. In an example embodiment, the composite image may be transmitted via transmitting means, which may also be referred as means for transmitting. An example of the transmitting means may be a transceiver, which may be an example, of communication interface 408.

At block 706, the composite image comprising a plurality of images is received, for example by the receiving apparatus 300. In an example embodiment, the composite image may be received via receiving means, which may also be referred as means for receiving. An example of the receiving means may be a transceiver, which may be an example, of the communication interface 308.

At block 708, selection of individual images from the composite image is enabled. In an example embodiment, the user of the receiving apparatus 300 is enabled to select the individual images. In an example embodiment, the individual images are selected without receiving an input from the user. In an example embodiment, a processing means may cause a user interface means to enable the user to select individual images from the composite image. Individual image selected by the user may be determined by image boundaries. Alternatively or additionally, if the user did not select inside the defined axis of an image, a closest image to corresponding central point is determined as a selected image. An example of the processing means may include the processor 302, which may be an example of the controller 208. An example, of the user interface means may include an input module, which may be an example of the user interface 306. In an example embodiment, the user may zoom in to the composite image prior to selecting individual images. Zooming may help the user to effectively select individual images.

At block 710, a request is sent by the receiving apparatus 300 for the individual images. In an example embodiment, the request may be sent via transmitting means. An example, of the transmitting means may be the transceiver, which may be an example, of the communication interface 308. In an example embodiment, the request may be sent automatically once selection of the individual images is complete.

At block 712, the request for the individual images is received by the transmitting apparatus 400. In an example embodiment, a receiving means in the transmitting apparatus 400 may receive the request. An example, of the receiving means may be a transceiver, which may be an example of the communication interface 408. In an example embodiment, the receiving apparatus 300 may be authenticated by the transmitting apparatus 400 at block 714. In an example embodiment, the receiving apparatus 300 may be authenticated by an authentication means. An example of the authentication means may be the authentication module 410. In an example embodiment, in which the receiving apparatus 300 is a mobile phone, the receiving apparatus 300 may be authenticated based on phone number of the receiving apparatus 300.

The requested individual images are transmitted to the receiving apparatus 300 at block 716. In an example embodiment, the individual images are transmitted by an another apparatus, which is different from the transmitting apparatus 400. In an example embodiment, the individual images may be transmitted by transmitting means. An example, of the transmitting means may be the transceiver, which may be an example of communication interface 408.

At block 718, the individual images are received by the receiving apparatus 300. In an example embodiment, the individual images are received from an another apparatus, which is different from the receiving apparatus 300. In this embodiment, the request for individual images also includes details of the another apparatus. In an example embodiment, the individual images are received via a receiving means. An example, of the receiving means may be a transceiver, which may be an example of the communication interface 308. In an example embodiment, blocks 710, 712, 714, 716, and/or 718 may be performed automatically, for example, without or minimal intervention from a user of the transmitting and/or receiving apparatuses. In an example embodiment, the received individual images may be stored at block 720. The images may be stored in the receiving apparatus 300 by using an application. The application may be any application that may be used to organize images and/or a folder on the receiving apparatus 300. Some examples of the application include multimedia applications, image galleries, and/or file folders stored in memory of the receiving apparatus 300. In an example embodiment, the received individual images may be stored on a storing means. An example, of storing means may be a volatile or a non-volatile memory, which may be an example of the memory 304.

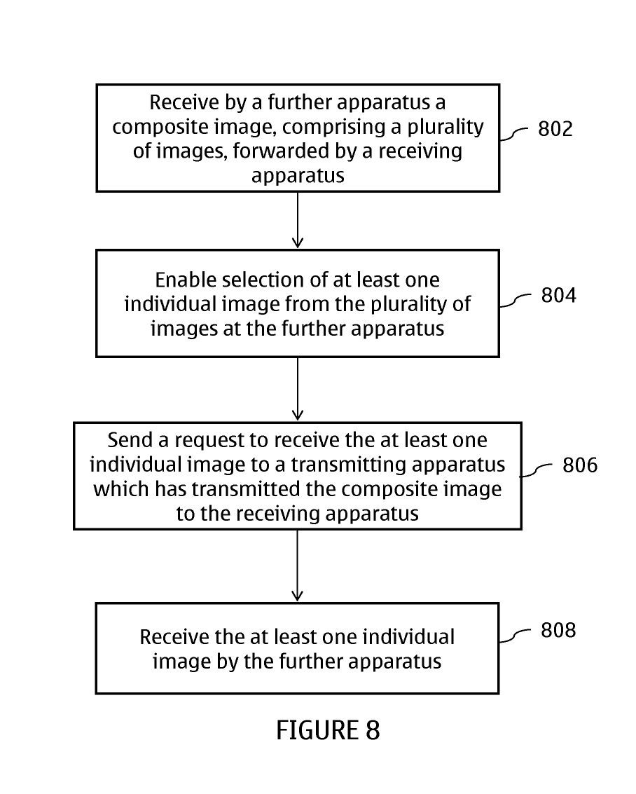

FIG. 8 is a flowchart depicting an example method for receiving images in accordance with another example embodiment. In an example embodiment, the receiving apparatus is allowed to forward the composite image to a further apparatus. The receiving apparatus may forward the composite image to share the images with a recipient of the further apparatus.

The further apparatus receives the composite image forwarded by the receiving apparatus at block 802. In an example embodiment, the further apparatus may be allowed to request individual images from the plurality of images in the composite image. Selection of the individual images from the composite image is enabled at block 804, if the further apparatus is allowed to request for the individual images. In an example embodiment, the user of the further apparatus is enabled to select the individual images. In another example embodiment, the further apparatus selects the individual images without receiving input from the user. A request for the individual images is sent to a transmitting apparatus at block 806. The transmitting apparatus is an apparatus that has sent the composite image to the receiving apparatus. In an example embodiment, the request for the individual images is sent automatically, for example, with no or minimal intervention by the user of the further apparatus. At block 808, the individual images are received by the further apparatus.

FIG. 9 depicts example formats of a composite image in accordance with an example embodiment. FIG. 9 is shown to include composite images 902, 904 and 906. The composite images 902 and 904 are in square format, for example, the boundary of the composite images 902 and 904 is square. The composite image 906 is in round format, for example, the boundary of the composite image 906 is round. Though FIG. 9 is shown to include round and circle formats, the composite image can be created by using other formats also.

A user may zoom into any of the composite images 902, 904, and 906. For example, the user may want to see images, in the composite image, in a larger size. If the user zooms closer, for example, 2 times to a particular image, it may be assumed that the user is interested in that image. An option to request the particular image may be triggered. An individual image corresponding to the zoomed image may be received from the transmitting apparatus. The received image may be displayed at the receiving apparatus. In an example embodiment, the transmitting apparatus may not be connected to the network. In this embodiment, the request may be left waiting in the network and as the transmitting apparatus connects, the image may be sent to the apparatus requesting the image. The received image may be displayed at the apparatus receiving the image.

Without in any way limiting the scope, interpretation, or application, a use case of an example embodiment is discussed with help of following example. In this example, a user captures more than two images of a family event and wants to share them with one or more of his friends by using a mobile communication device. The user accesses a photo gallery on the mobile communication device. The photo gallery is an application that is used to organize images taken with the mobile communication device. The user selects the images he wants to share with his friends. The user selects an option for creating a composite image that may be available in an application menu of the mobile communication device. Once this option is selected, the selected images are converted into a composite image.

In an example embodiment, the selected images may be scaled and processed for the data transfer based, for example, on the original image size and quality. The individual selected images in the composite image may be inseparable. The composite image may include a data file with consistent data for the composite image contents and detailed parameters of the selected image locations inside the composite image. This may enable the user or his friends to select any individual image inside the composite image. By accessing specific images inside the composite image, the user or the friends may be able to view details of the specific images based on the parameters of the original image and are able to request the specific image to be accessed.

Selecting the specific images in the composite image, on the mobile communication device on which the composite image is created, may open original images corresponding to the specific images from their original locations in the mobile communication device gallery.

In an example embodiment, the user may share the composite image with a friend. The user transmits the composite image to the friend. The friend may access the composite image by using a mobile phone, for example, the mobile phone 102 of FIG. 1. The friend selects some individual images from the composite image. A request is sent to the mobile communication device over a network for the individual images.

The request is received at the mobile communication device for receiving the individual images. The individual images are transmitted by the mobile communication device to the mobile phone, in response to receiving the request. The individual images are received by the mobile phone. The individual images may be sent automatically to the mobile phone. Additionally or alternatively, the mobile phone may be provided with an option to request and/or download the individual images from the mobile communication device. In an example embodiment, the mobile communication device may automatically approve the request. In another example embodiment, the mobile communication device may perform required security verification. For example, the mobile communication device may authenticate the mobile phone by using phone number of the mobile phone. The mobile communication device may check if the number of the mobile phone requesting the individual image is identical to which the composite image was sent.

Additionally or alternatively, the mobile communication device may automatically include an identifier inside a data file specific to a recipient, which may be used to verify the requests from the receiving apparatuses.

Without in any way limiting the scope, interpretation, or application of the claims appearing below, a technical effect of one or more of the example embodiments disclosed herein is to share composite images in a network. Another technical effect of one or more of the example embodiments disclosed herein is to receive individual images selected by a user of a device receiving a composite image. Another technical effect of one or more of the example embodiments disclosed herein is to restrict a user of the device receiving a composite image from forwarding the composite image to a further apparatus.

Various embodiments described above may be implemented in software, hardware, application logic or a combination of software, hardware and application logic. The software, application logic and/or hardware may reside on at least one memory, at least one processor, an apparatus or, a computer program product. If desired, part of the software, application logic and/or hardware may reside on a device transmitting a composite image, part of the software, application logic and/or hardware may reside on a device receiving the composite image. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 2, 3, and/or 4. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
receiving a composite image comprising a plurality of images;
sending a request over a network for at least one individual image; and
receiving the at least one individual image.

2. (canceled)

3. A method according to claim 1, wherein a resolution of the plurality of images in the composite image is less than the resolution of the received at least one individual images.

4. A method according to claim 1, wherein a size of the plurality of images in the composite image is less than a size of the received at least one individual images.

5. (canceled)

6. A method according to claim 1, wherein the at least one individual image is received separately from the composite image.

7. (canceled)

8. A method according to claim 1, further comprising authenticating the receiving apparatus from which the request is received.

9-11. (canceled)

12. A method according to claim 1, further comprising forwarding the composite image to a further apparatus.

13. A method according to claim 12, further comprising:
receiving, by the further apparatus, the forwarded composite image;
sending a request over network for receiving at least one individual image; and
receiving the at least one individual image.

14-16. (canceled)

17. A method according to claim 1, wherein the composite image comprises a collage from which the individual images are inseparable.

18-19. (canceled)

20. An apparatus, comprising:
at least one processor; and
at least one memory comprising computer program code, the at least one memory and the computer program code configured to, with the at least one processor, cause the apparatus at least to perform:
receive a composite image comprising a plurality of images;
sending a request over a network for at least one individual image; and
receive the at least one individual image.

21-22. (canceled)

23. An apparatus according to claim 20, wherein the at least one individual image is received separately from the composite image.

24-26. (canceled)

27. An apparatus comprising:
at least one processor; and
at least one memory comprising computer program code, the at least one memory and the computer program code configured to, with the at least one processor, cause the apparatus at least to perform:
transmit a composite image comprising a plurality of images;
receive a request over a network for sending at least one individual image from the plurality of images selected by a recipient of the composite image; and
transmit the at least one individual image.

28. (canceled)

29. An apparatus according to claim 27, wherein the at least one individual image is transmitted separately from the composite image.

30. An apparatus according to claim 27, wherein the memory and the computer program code are configured to, with the at least one processor, further cause the apparatus at least to perform:
authenticate a recipient device from which the request is received.

31-36. (canceled)

37. A computer program product comprising computer program instructions which when executed by an apparatus cause the apparatus to perform:
receiving a composite image comprising a plurality of images;
sending a request over a network for at least one individual image; and
receiving the at least one individual image.

38-39. (canceled)

40. A computer program product according to claim 37, wherein the at least one individual image is received separately from the composite image.

41-53. (canceled)

54. An apparatus according to claim 20, wherein at least one of:
a resolution of the plurality of images in the composite image is less than the resolution of the received at least one individual images; and
a size of the plurality of images in the composite image is less than a size of the received at least one individual images.

55. An apparatus according to claim 20, wherein the composite image comprises a collage from which the individual images are inseparable.

56. An apparatus according to claim 27, wherein at least one of:
a resolution of the plurality of images in the composite image is less than the resolution of the transmitted at least one individual images; and
a size of the plurality of images in the composite image is less than a size of the transmitted at least one individual images.

57. An apparatus according to claim 27, wherein the composite image comprises a collage from which the individual images are inseparable.

58. A computer program product according to claim 37, wherein the composite image comprises a collage from which the individual images are inseparable.
